(19) United States
(12) Patent Application Publication
(10) Pub. No.: US 2004/0254886 A1
(43) Pub. Date: Dec. 16, 2004

(54) Method and system for outputting protected data in a vehicle

(76) Inventors: Peter Siepen, Hildesheim (DE); Holger Kussmann, Giesen (DE); Michael Wollborn, Hannover (DE); Lars Placke, Hannover (DE)

Correspondence Address: KENYON & KENYON, ONE BROADWAY, NEW YORK, NY, 10004, US

(21) Appl. No.: 10/814,501

(22) Filed: Mar. 31, 2004

(30) Foreign Application Priority Data
Mar. 31, 2003 (DE) 10314440.4

(51) Int. Cl. G06F 17/60

(52) U.S. Cl. 705/51

(57) ABSTRACT

A method and a system for outputting protected, in particular encrypted, useful data in a vehicle. A usage authorization of the data in the vehicle is granted as a function of the road traveled or the area traveled.

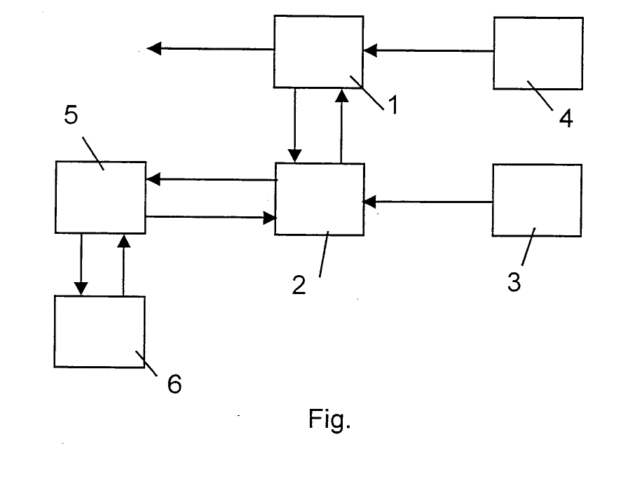

### FIELD OF THE INVENTION

The present invention relates to a method for outputting protected, in particular encrypted, useful data in a vehicle and a system for implementing such a method.

### BACKGROUND INFORMATION

Cashless and wireless toll systems which automatically deduct the toll fees due either from the account of the driver or from a balance existing with the operator of the toll road when a toll road is traveled are known from the related art. Such a system, the toll box, typically operates independently and is connected to further vehicle systems in certain circumstances.

In addition, playing back data having a radio-based or media-based content, referred to as useful data, in vehicles is known. An example of a radio-based content is broadcast radio, both in analog and in digital forms. In this case, GSM-based streaming is also possible. The classical media such as cassette, CD, or DVD are included in media-based content, and alternative storage media such as CD-ROM or flash memory cards may also be used.

Furthermore, methods for digital rights management (DRM), in which the useful data to be relayed is transmitted separately from the rights for using this data and generally encrypted, are known. The encrypted transmission of the useful data may be performed, for example, as a complete file or in the form of streaming data. The usage right or the license for playing back the file or the streaming data is received separately from the encrypted useful data and typically also from another source. The key for decrypting the useful data and also the usage rights acquired with the license are contained in this license.

### SUMMARY OF THE INVENTION

Based on this related art, an object of the present invention is to provide a method and a system, using which useful data may be provided to a defined user group for playback.

According to the present invention, this is achieved in that usage authorization for the data in the vehicle is granted as a function of the road traveled or the area traveled. The system provides that a playback unit is coupled to a rights analysis unit, in which it is checked whether a location-dependent usage right exists for the encrypted useful data to be played back, so that the useful data may be played back, and whether the vehicle is located in the area or on the road for which a usage authorization exists.

The system and method according to the present invention allow encrypted useful data to be made accessible in a locally limited way, so that, for example, the playback of contents protected by DRM methods is coupled to the usage of toll roads or the travel in specific regions. For this purpose, a usage right, which permits the playback of the content only in the event of simultaneous usage of a specific road or a specific area and/or a defined group of roads, is transmitted together with or separately from the actual useful data, which is provided encrypted.

A refinement of the method provides that the useful data is transmitted via a radio signal into the vehicle, it is provided here, however, in encrypted form, and may not be played back understandably without a decoding key. Alternatively to this, the useful data is provided in the vehicle on a storage medium, which is transferred to the vehicle driver at a toll point or distribution point. The useful data is also provided in encrypted form on the storage medium, so that playback is not possible without a corresponding decoding key.

The usage authorization is advantageously transmitted via a radio signal into the vehicle, the point in time of the transmission of the rights being coupled to passing through a toll point having a transponder or driving over a specific area border, for example, so that the useful data may be decrypted and played back from the point in time at which the vehicle is located on the toll road or in a specific area. As an alternative to a wireless data transmission of the usage authorization, the authorization may be provided on a storage medium in the vehicle and activated as soon as a specific area or a specific road is traveled.

It is advantageously determined via a navigation system whether the vehicle is located inside a specific area for which a usage authorization has been granted and/or whether the vehicle is located on a specific highway or toll road or a group of toll roads for which a usage authorization is granted. In this way, a usage authorization may be checked automatically as a function of the location at which the vehicle is located and, if the authorization exists, decryption of the protected data may be performed.

Since the usage of protected data is typically connected with costs, a fee for the usage authorization is advantageously electronically deducted as soon as the useful data is requested or played back or as soon as a specific area or a specific road is traveled for which the usage authorization has been applied for.

An embodiment of the method provides that a rights analysis unit, which is coupled to a playback unit, checks whether a usage right exists at all for the useful data to be played back. If so, either decryption of the useful data is performed in the rights analysis unit or a decoding key is transmitted from the rights analysis unit to the playback unit, and the useful data is then decrypted and prepared for playback there.

A refinement provides that the usage right is granted with a time restriction, so that in addition to the location dependence, there is also a time dependence of the usage authorization. It is also possible for the usage right to be granted only for a specific road type, for toll roads of a specific operating company in particular, so that the content of the useful data may also be used company-wide.

The system for implementing the method provides that a playback unit is coupled to a rights analysis unit, and the rights analysis unit checks whether there is a location-dependent usage right for the encrypted useful data to be played back. In addition to a simple location dependence, there may also be a road-dependent usage right, so that traveling specific road types authorizes the usage of specific data. If a usage right exists, the useful data may be played back, and it is checked whether the vehicle is located in the area or on the road for which a usage authorization exists.

The rights analysis unit is advantageously coupled to a navigation system in order to establish the current location data of the vehicle and to check on the basis of this location data whether the necessary parameters for the usage of the data transmitted to the vehicle or provided in the vehicle are fulfilled.

Through the method and system according to the present invention, the possibility offers itself of distributing contents via generally accessible media such as radio, CD, DVD, etc. and only making them accessible to the actual users of a toll road and/or a highway, a highway type, or an area. Examples of such transmitted contents are radio programs, music, videos, maps, and route data for navigation systems, traffic, travel, hotel, or restaurant information, weather or stock exchange information, or Internet data. The transmitted data is protected from unauthorized usage by the DRM method used, so that the safeguarding of the copyrights is ensured. Defined target groups are addressed through the restricted and checked user circle, so that licensing fees for the suppliers of these contents may become more favorable.

### BRIEF DESCRIPTION OF THE DRAWING

The FIGURE shows a block diagram of an exemplary embodiment of the method and/or the system according to the present invention.

### DETAILED DESCRIPTION

The FIGURE shows a multimedia playback unit 1, which is bidirectionally coupled to a rights analysis unit 2. A storage unit 3 for digital rights is coupled to rights analysis unit 2, so that digital rights may be transmitted to rights analysis unit 2 from storage unit 3 for digital rights. This transmission may be performed either via radio or by inserting a storage medium. The playback unit 1 is connected to a data memory 4 for multimedia data or a receiver unit for useful data, this useful data being transmitted encrypted to playback unit 1.

In a first embodiment, a query as to whether a corresponding key exists for the encrypted data is directed from the playback unit 1 to rights analysis unit 2. If there is such a key, it is transmitted to playback unit 1; decoding is performed there and the multimedia data may be output in the vehicle.

A variation to this method provides that encrypted data from multimedia playback unit 1, which was received by the data memory or receiver unit 4, is transmitted to rights analysis unit 2, in which the encrypted data is decrypted and transmitted back to playback unit 1.

Rights analysis unit 2 is coupled to a toll box 5, via which information is obtained on whether the vehicle is located on a specific road or whether the vehicle is located on a specific road type, such as toll roads of a specific operating company. This toll box 5 may be coupled to a navigation system 6, navigation system 6 transmitting the current position of the vehicle in response to a corresponding query of toll box 5.

Rights analysis unit 2 therefore analyzes the right transmitted by the memory unit for digital rights 3 and checks whether the vehicle is located on a road which authorizes a usage of the data. Using this information, rights analysis unit 2 may then decide whether the encrypted content of the useful data may be played back. In this way, it is possible to couple the usage of a toll road to the reception and/or the playback of multimedia data.

During the transmission of the useful data from data memory 4 and/or receiver unit 4, protected useful data is transmitted to playback unit 1; this may occur, as already described, in the form of a data carrier or via an analog or digital radio signal.

In principle, in the event of transmission via a radio link, the encrypted useful data signal may be received by a circle of persons which exceeds the number of those authorized for usage. Data carriers may also be distributed freely, however, the protected content of the useful data is only released to an actually authorized user, preferably a user of a toll road, by a usage right being transmitted separately from the useful data. This usage right allows the usage of the content of the transmitted data on the corresponding toll road and/or highway or within the specific area.

If the user desires the playback of the data content, playback unit 1 determines that the data content is encrypted, since it is protected via a DRM method. Subsequently, it is queried at rights analysis unit 2 whether there is a usage right for the data set desired. Rights analysis unit 2 then checks whether there is a usage right; if so, the conditions for the playback of the data content are checked. These include, in addition to the typical DRM-specific conditions, such as the restriction of the period in time in which the playback of the data content may occur, that the vehicle is located on a specific road and/or inside a specific area.

For checking, rights analysis unit 2 analyzes the usage right associated with the particular data content. If there is a usage right which allows playback only during the use of a specific road, rights analysis unit 2 requests the current status from toll box 5. If this query shows that the vehicle is located on a toll road which is covered by the usage right, rights analysis unit 2 requests the current position from toll box 5. Optionally, toll box 5 operates together with a navigation system 6, which is installed in the vehicle, to determine the position. A further option provides that rights analysis unit 2 is connected directly to navigation system 6.

If the above-mentioned conditions have been fulfilled, playback unit 1 receives a key from rights analysis unit 2 in order to decrypt the encrypted useful data set and play it back. Alternatively, the useful data set is transmitted to rights analysis unit 2 and decrypted there. In order to be able to delimit the region of playback as precisely as possible, it is enquired at regular intervals in the rights analysis unit whether the conditions for the playback of the useful data set are still provided, in particular, whether the usage time has expired and whether the vehicle is still located in the specific area in which the usage right was granted.

An application example provides that an expressway operating company wishes to transmit specific songs to its customers on a specific road. For this purpose, it distributes CDs at its offices or even by mail, each of which contains the current songs in a compressed and DRM-based audio format. The CDs may therefore not be played back without a corresponding digital right, since they are provided encrypted. During travel on the specific toll road, together with the automatic and electronic deduction of the toll fee from the balance of the customer, a digital right is transmitted which allows the playback of the pieces of music contained on the CD during the drive on the toll road. It is also provided that this right for playback of the pieces of music is only valid for a specific period of time.

For the playback of broadcast radio services, it may be possible that an expressway operating company wishes to make its own broadcast radio program available. In order to save on licensing fees for the music playback, it is advisable to make the broadcast radio program accessible only to actual customers. The program is therefore digitally broadcast using a DRM method in the vicinity of its expressway sections. Without a usage right, which is provided either via radio or on a storage medium in the vehicle, a program may not be decrypted and therefore may also not be played back. During the application for and setup of a user account for paying the toll fees, a digital right is simultaneously handed over to the customer, on a memory card, for example, which the customer may play in his playback device 1. During travel on a road section operated by the company, the playback of the broadcast radio program is made possible by the usage right and the DRM system.

In addition to the playback of audio signals, availability of different media, such as images, video, Internet, etc., will be provided combined with audio signals. These media are advantageously available only during the usage of the specified toll road; it may be provided that a usage is available for a limited period of time before and/or after the usage of the toll road, so that a song may be heard completely or a film may be viewed to its end or even so that a story may be followed to the end.

In addition to a time restriction, a limited number of accesses may be available before, after, or during the usage of the toll road, so that a specific number of pieces of music may be called for a specific maximum count and/or a film may be viewed precisely once. One or more encrypted digital or analog radio or television programs may be transmitted in encrypted form. The data transmitted may be transmitted from a data server to the user of the vehicle via a wireless radio link.

Furthermore, it is possible that the usage rights are obtained by the user in the store, via Internet, or by radio before beginning travel and introduced into the vehicle. This is possible as a replaceable data carrier, PDA, or via a wireless connection. It is also possible for the digital usage rights to be transmitted wirelessly into the vehicle during the usage of the toll road continuously or repeated periodically, so that a precise detection of the duration of the usage is possible.

What is claimed is:

1. A method for outputting protected useful data in a vehicle, the method comprising:
granting a usage authorization of the data in the vehicle as a function of one of a road traveled and an area traveled.

2. The method according to claim 1, wherein the data is encrypted data.

3. The method according to claim 1, further comprising transmitting the useful data via a radio signal into the vehicle.

4. The method according to claim 1, further comprising providing the useful data on a storage medium in the vehicle.

5. The method according to claim 1, further comprising transmitting the usage authorization via a radio signal into the vehicle.

6. The method according to claim 1, further comprising providing the usage authorization on a storage medium in the vehicle.

7. The method according to claim 1, further comprising determining using a navigation system whether the vehicle is located inside the area for which a usage authorization was granted.

8. The method according to claim 1, further comprising electronically debiting a fee for the usage authorization as soon as one of (a) the useful data is played back, (b) a specific area is traveled and (c) a specific road is traveled.

9. The method according to claim 1, further comprising checking in a rights analysis unit, which is coupled to a playback unit, whether a usage right exists for the useful data to be played back.

10. The method according to claim 9, further comprising decrypting the useful data in the rights analysis unit.

11. The method according to claim 9, further comprising:
transmitting a decoding key from the rights analysis unit to the playback unit; and
decrypting the useful data in the playback unit using the decoding key.

12. The method according to claim 9, further comprising granting the usage right with a time restriction.

13. The method according to claim 9, further comprising granting the usage right for a specific road type.

14. The method according to claim 13, wherein the usage right is granted for toll roads of an operating company.

15. A system for outputting encrypted useful data in a vehicle comprising:
a playback unit; and
a rights analysis unit, coupled to the playback unit, for checking whether one of a location-dependent and a road-dependent usage right exists for the encrypted useful data to be played back, so that the useful data can be played back, and for checking whether the vehicle is located one of (a) in an area and (b) on a road for which a usage authorization exists.

16. The system according to claim 15, further comprising a navigation system coupled to the rights analysis unit for determining current location data of the vehicle.
